(19) United States
(12) Patent Application Publication
(10) Pub. No.: US 2024/0254012 A1
(43) Pub. Date: Aug. 1, 2024

(54) SYSTEMS AND METHODS FOR COAL-BASED ELECTROTHERMAL SWING ADSORPTION OF AQUEOUS GREENHOUSE GASES FROM WASTEWATER

(71) Applicant: CARBON HOLDINGS INTELLECTUAL PROPERTIES, LLC, Ranchester, WY (US)

(72) Inventors: Charles S. Hill, Sheridan, WY (US); Garrett W. Lindemann, Buffalo, WY (US)

(21) Appl. No.: 18/426,085

(22) Filed: Jan. 29, 2024

Related U.S. Application Data
(60) Provisional application No. 63/481,987, filed on Jan. 27, 2023.

(51) Int. Cl. C02F 1/28

(52) U.S. Cl. CPC C02F 1/283; C02F 2301/08; C02F 2303/16

(57) ABSTRACT

In at least one example, an electrothermal swing adsorption system includes an electrothermal swing adsorption apparatus. The electrothermal swing adsorption apparatus includes a first chamber comprising at least one carbon monolith and a second chamber comprising at least one carbon monolith. The electrothermal swing adsorption apparatus receives a feed of a wastewater with at least one greenhouse gas dissolved therein, outputs a purified water flow stream, and outputs a concentrated aqueous greenhouse gas flow stream.

### CROSS-REFERENCE TO RELATED APPLICATION

This patent application is a nonprovisional patent application of, and claims priority to, U.S. Provisional Application No. 63/481,987 filed Jan. 27, 2023, and titled “Systems and Methods for Coal-Based Electrothermal Swing Adsorption of Aqueous Greenhouse Gases from Wastewater,” the disclosure of which is hereby incorporated herein by reference in its entirety.

### FIELD

The described embodiments relate generally to a coal-based electrothermal swing adsorption system that captures, concentrates, and sequesters aqueous greenhouse gases. More particularly, the present embodiments relate systems, apparatuses, and methods for capturing, concentrating, and sequestering aqueous greenhouse gases from wastewater treatment train of Water Resources Recovery Facilities.

### BACKGROUND

Wastewater is water generated after the use of freshwater, raw water, drinking water or saline water in a variety of deliberate applications or processes. Another definition of wastewater is used water from any combination of domestic industrial, commercial, or agricultural activities, surface runoff/storm water, and any sewer inflow or sewer infiltration. Water Resources Recovery Facilities produce clean water, nutrients, renewable energy and other valuable bio-based materials from wastewater. Most wastewater contains aqueous greenhouse gases and the wastewater is treated at a local wastewater facility or water resources recovery facility to remove the aqueous greenhouse gases from the wastewater. Aqueous greenhouse gases may include methane, nitrous oxide, carbon monoxide, and carbon dioxide. Conventionally, granulated activated carbon is used to remove aqueous greenhouse gases.

### SUMMARY

In at least one example, an electrothermal swing adsorption system includes an electrothermal swing adsorption apparatus. The electrothermal swing adsorption apparatus includes a first chamber comprising at least one carbon monolith and a second chamber comprising at least one carbon monolith. The electrothermal swing adsorption apparatus receives a feed of a wastewater with at least one greenhouse gas dissolved therein, outputs a purified water flow stream, and outputs a concentrated aqueous greenhouse gas flow stream.

In one example, the at least one carbon monolith of the first chamber adsorbs aqueous greenhouse gases and the at least one carbon monolith of the second chamber desorbs greenhouse gases simultaneously as the at least one carbon monolith of the first chamber adsorbs aqueous greenhouse gases. In one example, the at least one carbon monolith of the second chamber adsorbs aqueous greenhouse gases and the least one carbon monolith of the first chamber desorbs greenhouse gases simultaneously as the at least one carbon monolith of the first chamber adsorbs aqueous greenhouse gases. In one example, the first chamber and the second chamber operate in a cyclical fashion to perform continuous adsorption and desorption of greenhouse gases such that adsorption occurs in one of the first chamber and the second chamber, while desorption occurs in the other of the first chamber and the second chamber. In one example, each carbon monolith comprises coal-based activated carbon fibers. In one example, each carbon monolith is functionalized to adsorb a specific aqueous greenhouse gas. In one example, the electrothermal swing adsorption apparatus comprises a container to store aqueous greenhouse gases desorbed from the second carbon monolith. In one example, the electrothermal swing adsorption system further includes a plurality of electrothermal swing adsorption apparatuses that are arranged in series such that each electrothermal swing adsorption apparatus adsorbs aqueous greenhouse gases from the feed of the wastewater. In one example, each electrothermal swing adsorption apparatus outputs a concentrated aqueous greenhouse gas flow stream for a specific aqueous greenhouse gas. In one example, each electrothermal swing adsorption apparatus comprises a container to store the outputted specific aqueous greenhouse gas. In some examples, the electrothermal swing adsorption apparatus further includes at least one chromatography column configured to adsorb the at least one greenhouse gas dissolved in the wastewater.

In at least one example, a method of removing greenhouse gases from wastewater utilizing a electrothermal swing adsorption system includes feeding wastewater with aqueous greenhouse gases into a first chamber of an electrothermal swing adsorption apparatus, adsorbing the aqueous greenhouse gases with a first carbon monolith in the first chamber, and outputting a purified water flow stream from the first chamber of the electrothermal swing adsorption apparatus. In one example, the method further includes feeding purge water into a second chamber of the electrothermal swing adsorption apparatus that is separate from the first chamber, and desorbing greenhouse gases from a second carbon monolith with the purge water in the second chamber, wherein the second carbon monolith previously adsorbed aqueous greenhouse gases. In one example, the method further includes outputting a concentrated aqueous greenhouse gas flow stream from the second chamber of the electrothermal swing adsorption apparatus.

In one example, the method further includes applying an electrical current to the second carbon monolith in the second chamber to raise a temperature of the second carbon monolith to desorb the greenhouse gases from the second carbon monolith. In one example, the method further includes reversing the feed of the wastewater with aqueous greenhouse gases from the first chamber to the second chamber and reversing the feed of the purge water from the second chamber to the first chamber when the first carbon monolith has adsorbed a predetermined amount of aqueous greenhouse gases.

In one example, adsorbing the aqueous greenhouse gases with a first carbon monolith in the first chamber can include moving the first carbon monolith through the wastewater and/or purge water or gas. In an example, the method further includes adsorbing the aqueous greenhouse gases with the second carbon monolith in the second chamber, and desorbing greenhouse gases from the first carbon monolith with the purge water in the first chamber. In one example, the first carbon monolith and the second carbon monolith comprise coal-based activated carbon fibers. In one example, the coal-based activated carbon fibers are functionalized to adsorb a specific aqueous greenhouse gas. In one example, the electrothermal swing adsorption system comprises a plurality of electrothermal swing adsorption apparatuses that are arranged in series, wherein the wastewater with aqueous greenhouse gases is feed into each electrothermal swing adsorption apparatus in series and each electrothermal swing adsorption apparatus adsorbs a specific aqueous greenhouse gas.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 illustrates a schematic of an electrothermal swing adsorption system with a plurality of electrothermal swing adsorption apparatuses according to one embodiment of the present disclosure.

FIG. 2 illustrates a schematic of an electrothermal swing adsorption apparatus in a first configuration according to one embodiment of the present disclosure.

FIG. 3 illustrates a schematic of the electrothermal swing adsorption apparatus of FIG. 2 in a second configuration.

FIG. 4 illustrates a flowchart of a method of capturing, concentrating, and sequestering aqueous greenhouse gases from wastewater in a wastewater treatment train.

### DETAILED DESCRIPTION

The present description provides examples, and is not limiting of the scope, applicability, or configuration set forth in the claims. Thus, it will be understood that changes can be made in the function and arrangement of elements discussed without departing from the spirit and scope of the disclosure, and various embodiments can omit, substitute, or add other procedures or components, as appropriate. For instance, methods described can be performed in an order different from that described, and various steps can be added, omitted, or combined. Also, features described with respect to some embodiments can be combined in other embodiments.

Aqueous greenhouse gases, such as methane, nitrous oxide, carbon monoxide, and carbon dioxide, are found in wastewater. Conventional granulated activated carbon is used to remove aqueous greenhouse gases from wastewater. The present disclosure is directed to an electrothermal swing adsorption system that utilizing carbon monoliths with active carbon fibers to capture, concentrate, and sequester greenhouse gas emissions. The electrothermal swing adsorption system includes two phases: capture/adsorption and release/desorption. Activation includes capturing/adsorbing aqueous greenhouse gases with a carbon monolith. Activation results in significant reduction of aqueous greenhouse gases from wastewater, mainly the concentrations of methane, nitrous oxide, carbon monoxide, and nitrates from wastewater. Regeneration is the release/desorption of the capture aqueous greenhouse gases and is accomplished by draining the water from the chamber before applying an electric current through the active carbon monolith causing the internal temperature to increase to between 100° and 150° C.

The electrothermal swing adsorption system is to remove aqueous greenhouse gases from water resources recovery facilities treatment train. The electrothermal swing adsorption system is designed and scaled for industrial and municipal wastewater treatment facilities. To provide the capacity to filter water in a timely manner, we will develop a system operating in parallel and in-train to allow for the continuous capture of aqueous greenhouse gases and recharging of the filters as needed in a cyclical process. Carbon fibers conduct electricity and heat, the amount of energy needed through the electrothermal swing process to increase temperatures can be relatively low. Researchers have attempted to regenerate the active carbon monoliths using gas burners or external resistance elements; however, the electrothermal swing adsorption/desorption cycle is simpler, easier to apply and control, and less energy intensive.

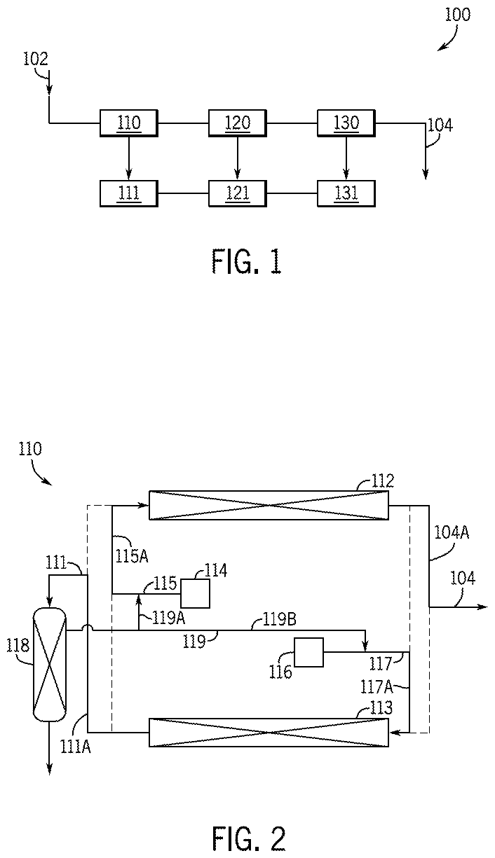

FIG. 1 illustrates an electrothermal swing adsorption system 100 for capturing, concentrating, and sequestering aqueous greenhouse gases accordingly to one embodiment of the present disclosure. The electrothermal swing adsorption system 100 comprises a wastewater input flow stream 102 and a purified water output flow stream 104 of purified water that was purified during wastewater purification process of the electrothermal swing adsorption system 100. The term purified does not necessarily mean the entirely fee of aqueous greenhouse gases, but means that the concentration of aqueous greenhouse gases in the water is significantly reduced. The wastewater input flow stream 102 may include aqueous greenhouse gases. The wastewater in the wastewater input flow stream 102 may include a variety of greenhouse gases, such as methane (CH₄), nitrous oxide (N₂O), carbon monoxide (CO), and carbon dioxide (CO₂) dissolved in the wastewater.

The electrothermal swing adsorption system 100 may include a plurality of electrothermal swing adsorption apparatuses 110, 120, 130 that are arranged in series. The illustrated embodiment illustrates a first electrothermal swing adsorption apparatus 110, a second electrothermal swing adsorption apparatus 120, and a third electrothermal swing adsorption apparatus 130. In other words, the wastewater input flow stream 102 is purified by the first electrothermal swing adsorption apparatus 110, then is purified by the second electrothermal swing adsorption apparatus 120, and then is purified by the third electrothermal swing adsorption apparatus 130. However, the present disclosure is not so limited, and the electrothermal swing adsorption system 100 may comprise more or less than three electrothermal swing adsorption apparatuses to purify the wastewater input flow stream 102 of aqueous greenhouse gases.

In some embodiments, the electrothermal swing adsorption apparatuses 110, 120, 130, of the electrothermal swing adsorption system 100 may be arranged in parallel. In other words, the electrothermal swing adsorption apparatuses 110, 120, 130 may purify the wastewater input flow stream 102 simultaneously to increase the rate in which the aqueous greenhouse gases are removed from the wastewater input flow stream 102.

In addition, each of the electrothermal swing adsorption apparatuses 110, 120, 130 of the electrothermal swing adsorption system 100 comprise a concentrated aqueous greenhouse gas flow stream 111, 121, 131, of condensed or concentrated aqueous greenhouse gases that are outputted from the electrothermal swing adsorption apparatuses 110, 120, 130. Each electrothermal swing adsorption apparatus 110, 120, 130 may be functionalized for the adsorption of a specific greenhouse gas. For example, the first electrothermal swing adsorption apparatus 110 may be functionalized to remove methane from the wastewater input flow stream 102, the second electrothermal swing adsorption apparatus 120 may be functionalized to remove nitrous oxide from the wastewater input flow stream 102 after the first electrothermal swing adsorption apparatus 110 removed methane, and the third electrothermal swing adsorption apparatus 130 may be functionalized to remove carbon monoxide from the wastewater input flow stream 102 after the first electrothermal swing adsorption apparatus 110 and the second electrothermal swing adsorption apparatus 120 removed methane and nitrous oxide. The result is that the purified water output flow stream 104 is free of aqueous greenhouse gases. The electrothermal swing adsorption system 100 may include additional electrothermal swing adsorption apparatuses to remove other specific aqueous greenhouses gases from the wastewater input flow stream 102. For example, the a fourth electrothermal swing adsorption apparatus may be functionalized to remove carbon dioxide from the wastewater input flow stream 102 after the first electrothermal swing adsorption apparatus 110, the second electrothermal swing adsorption apparatus 120, and the third electrothermal swing adsorption apparatus 130 removed methane, nitrous oxide, and carbon monoxide.

In some examples, the electrothermal swing adsorption apparatus 110, 120, 130 may include an active carbon monolith for adsorbing aqueous greenhouse gases explained in greater detail below. In some examples, the electrothermal swing adsorption apparatus can include at least one chromatography column configured to adsorb the at least one greenhouse gas dissolved in the wastewater. The at least one chromatography column can be upstream, downstream, or in parallel with the active carbon monolith. In some examples, a series of two, three, or more chromatography columns can be included in the electrothermal swing adsorption system 100. The chromatography columns can be in series or parallel, and can be configured to separate the aqueous greenhouse gases based on differential adsorption of each dissolved compound or greenhouse gas to the adsorbent of the chromatography column as the compounds move through the column at different rates, which allows them to get separated in fractions.

In an example, the chromatography column can capture multiple compounds. For example, a wastewater feed can be introduced from the top of the column. The movement of the individual components of the wastewater feed occurs at different rates. The components with lower adsorption and affinity to the stationary adsorption material travel faster when compared to the greater adsorption and affinity with the stationary material. The components that move fast are removed first whereas the components that move slowly are eluted out last. With respect to this disclosure “elution” can be defined as a chemical process that involves removing a material's ions by ion exchange with another material. The chromatographic technique of extracting an adsorbed substance from a solid adsorbing media using a solvent. The “eluent” is the solvent or mobile phase that passes through the column. When the polarity of the eluent matches the polarity of the molecules in the sample, the molecules desorb from the adsorbent and dissolve in the eluent.

The fraction of the mobile phase or feed that transports the sample components is the eluent. The mixture of solute and solvent that exits the column is known as an “eluate.” The eluent in liquid chromatography is a liquid solvent. In this example, the eluent is the wastewater feed. In some examples, the stationary adsorption material can be passed through a wastewater feed tank and into a second bath for elution as a moving bed. In some examples, the chromatography columns can be used as stand-alone devices or in combination with manual or automated chromatography systems. In some examples, the chromatography columns can be combined with other electrothermal swing adsorption apparatus to form the electrothermal swing adsorption system 100.

A first concentrated aqueous greenhouse gas flow stream 111 may transfer or output the condensed or concentrated aqueous greenhouse gas to a first temporary storage container for storing the condensed or concentrated aqueous greenhouse gas. A second concentrated aqueous greenhouse gas flow stream 121 may transfer or output the condensed or concentrated aqueous greenhouse gas to a second temporary storage container for storing the condensed or concentrated aqueous greenhouse gas. A third concentrated aqueous greenhouse gas flow stream 131 may transfer or output the condensed or concentrated aqueous greenhouse gas to a third temporary storage container for storing the condensed or concentrated aqueous greenhouse gas. In some embodiments, the first, second, and third temporary storage containers are different temporary storage containers that store a specific aqueous greenhouse gas. In some embodiments, the first, second, and third temporary storage containers is the same temporary storage container that stores all of the different aqueous greenhouse gases dissolved in the wastewater.

FIG. 2 illustrates a schematic of the electrothermal swing adsorption apparatus 110 in a first configuration. While FIG. 2 illustrates only a schematic of the electrothermal swing adsorption apparatus 110 in the first configuration, the electrothermal swing adsorption apparatuses 120, 130 in the first configuration are similar to the schematic of the first electrothermal swing adsorption apparatus 110 in the first configuration.

The first electrothermal swing adsorption apparatus 110 includes a first chamber 112 and a second chamber 113. The first chamber 112 and the second chamber 113 each house at least one carbon monolith. In some embodiments, the first chamber 112 and the second chamber 113 each only house a single carbon monolith. In some embodiments, the first chamber 112 and the second chamber 113 may each house multiple carbon monoliths.

In the illustrated embodiment, the first chamber 112 includes an active carbon monolith for adsorbing aqueous greenhouse gases and the second chamber 113 includes a regenerating carbon monolith for desorbing captured greenhouse gases from the regenerating carbon monolith.

The regenerating carbon monolith in the second chamber 113 had previously adsorbed aqueous greenhouse gases. In some embodiments, the carbon monolith in the second chamber 113 has not yet adsorbed aqueous greenhouse gases when it is first placed in the second chamber 113. The first chamber 112 and the second chamber 113 operate in a cyclical fashion to perform continuous adsorption and desorption of aqueous greenhouse gases.

The carbon monoliths of the first chamber 112 and the second chamber 113 each comprises coal-based activated carbon fibers. The coal-based activated carbon fibers are procured from a coal feedstock, which allows them to be 50% to 75% more economical than existing fibers on the market produced from polyacrylonitrile (PAN), rayon, and petroleum pitch precursors. The carbon fiber is produced by melt blowing isotropic pitch derived from sub-bituminous carbon ore by the direct coal liquefaction process. These novel carbon fiber monoliths include the elimination of the need for a binder and the elimination of one carbonization step.

The carbon monoliths and the coal-based activated carbon fibers may be functionalized for the adsorption of a specific greenhouse gas. Functionalizing the activated carbon fibers to target specific compounds is possible given that this has been evaluated for oxygen containing functional groups and demonstrated for silica nanoparticle doped activated carbon fibers. For example, these modifications include the capture of direct and indirect aqueous greenhouse gases (e.g., methane, nitrous oxide, carbon monoxide, and carbon dioxide), dyes, organics, and metals. Properties of the activated carbon fibers may be tailored so that selective adsorption is achieved. Properties of the activated carbon fibers may include pore diameter, pore size distribution, Brunauer-Emmett-Teller (BET) surface area, thermal conductivity, bulk density, air permeability, and electrical resistance. In some examples, functionalizing can include binding proteins or perhaps releasing in response to varying electrical charges. This selective release could provide a carbon neutral methane. The carbon monolith of the first chamber 112 and the carbon monolith of the second chamber 113 may be similar so each carbon monolith targets the same specific greenhouse gas during adsorption.

For example, the bulk density of the carbon monoliths can be greater than about 0.05 g/cm³. In some examples, the bulk density of the carbon monolith can be within a range from about 0.05 g/cm³ to about 0.7 g/cm³. In some examples, the fiber areal weight range can include a bulk density less than about 0.7 g/cm³. In other examples, the bulk density can be less than 0.6 g/cm³, less than 0.5 g/cm³, or less than 0.1 g/cm³. In some examples the bulk density of the carbon monoliths can be in ranges between about 0.05 g/cm³ and about 0.2 g/cm³. Other ranges can include between about 0.2 g/cm³ and about 0.4 g/cm³, between about 0.4 g/cm³ and about 0.5 g/cm³, between about 0.5 g/cm³ and about 0.6 g/cm³, or between about 0.6 g/cm³ and about 0.7 g/cm³. In some examples, the bulk density can be adjusted by adjusting the temperature rate while forming the carbon fiber monolith, but can also be adjusted by adjusting the airflow or oxygen concentration while forming the carbon fiber monolith.

In some examples, the air permeability of the carbon monoliths can vary based primarily on the bulk density. In some examples, the air permeability can also be affected by the fiber spacing and degree of melting at the nodes while forming the carbon fiber monoliths. In some examples, the air permeability of the carbon monolith can be within a range from about 1×10⁻¹⁰ m² to about 8.5×10⁻¹¹ m². In some examples, the air permeability range can be less than about 9.8×10⁻¹¹ m². In other examples, the air permeability can be less than about 9.5×10 m, less than about 9.0×10⁻¹¹ m², or less than about 8.8×10⁻¹¹ m². In some examples the air permeability of the carbon monoliths can be in ranges between about 1×10⁻¹⁰ m² and about 9.8×10⁻¹¹ m². Other ranges can include between about 9.8×10⁻¹¹ m² and about 9.5×10⁻¹¹ m², between about 9.5×10⁻¹¹ m² and about 9.3×10⁻¹¹ m², between about 9.3×10⁻¹¹ m² and about 9×10⁻¹¹ m², between about 9×10⁻¹¹ m² and about 8.8×10⁻¹¹ m², or between about 8.8×10⁻¹¹ m² and about 8.5×10⁻¹¹ m² The intrinsic permeability of a porous medium, such as a carbon monolith, measures its ability of letting a fluid pass through it under the influence of a pressure gradient. For practical applications, it is of high interest to predict the permeability of a given medium based on its porous structure.

Furthermore, properties of the activated carbon fibers can also be tailored to decrease the temperature and energy needed to desorb the greenhouse gases from the carbon monolith. As discussed in further detail below, an electric current can be applied to the carbon monolith to induce heat by electrical resistance of the carbon fibers in the carbon monoliths and increase their temperature to aid in the desorption process to remove the greenhouse gases from the regenerating carbon monolith.

The first electrothermal swing adsorption apparatus 110 includes a wastewater feed 114. The wastewater feed 114 may be the same as the wastewater input flow stream 102. The wastewater feed 114 includes aqueous greenhouse gases that are dissolved in the wastewater. The wastewater feed 114 of wastewater may include a variety of different aqueous greenhouse gases, such as methane, nitrous oxide, carbon monoxide, and carbon dioxide dissolved in the wastewater.

The wastewater feed 114 follows a wastewater feed flow path 115 that includes a first wastewater feed flow path 115A. The wastewater feed flow path 115 is introduced or received into the first chamber 112 via the first wastewater feed flow path 115A. The aqueous greenhouse gases are adsorbed by the active carbon monolith in the first chamber 112 thereby purifying the wastewater feed 114. The first chamber 112 is coupled to the purified water output flow stream 104 so that the purified wastewater feed 114 can exit the first chamber 112 via the first purified water output flow stream 104A. The purified water output flow stream 104, 104A is free of aqueous greenhouse gases as they were desorbed by the active carbon monolith in the first chamber 112. In some embodiments, the purified water output flow stream 104, 104A is free of the specific greenhouse gas that the carbon monolith in the first chamber 112 was functionalized for and may include additional aqueous greenhouse gases that will be removed by subsequent electrothermal swing adsorption apparatuses (e.g., 120, 130) that are disposed later in series of the wastewater input flow stream 102 of the electrothermal swing adsorption system 100. As discussed above, the purified water output flow stream 104, 104A may then be introduced into the second electrothermal swing adsorption apparatus 120 and then the third electrothermal swing adsorption apparatus 130. After the wastewater feed 114 is outputted from all of the electrothermal swing adsorption apparatuses 110, 120, 130 as the purified water output flow stream 104, the electrothermal swing adsorption system 100 can achieve significant reduction of aqueous greenhouse gases and nitrates.

The first electrothermal swing adsorption apparatus 110 further includes a purge 116. The purge 116 is a reservoir of purge water that is used in the desorption of the greenhouse gases from the carbon monolith in the second chamber 113. In some embodiments, a purge gas is used in the desorption process. The purge 116 follows a purge flow path 117 that includes a first purge flow path 117A. The purge 116 is introduced or received into the second chamber 113 via the first purge flow path 117A. The greenhouse gases are desorbed from the regenerating carbon monolith in the second chamber 113. The regeneration of the regenerating carbon monolith in the second chamber 113 is performed by applying an electric current to the regenerating carbon monolith to induce heat by electrical resistance of carbon monolith and increase the temperature of the carbon monolith to between 100° and 150° C. depending on the properties of the carbon monolith in the second chamber 113, the captured greenhouse gases being desorbed from the carbon monolith, and any chemical modifications of the carbon monolith. In some embodiments, the purge water is drained from the chamber before applying the electric current through the carbon monolith. The greenhouse gases are desorbed from the carbon monolith and into the purge 116. The condensed or concentrated aqueous greenhouse gases may be outputted out of the second chamber 113 through the concentrated aqueous greenhouse gas flow stream 111 via a first concentrated aqueous greenhouse gas flow stream 111A.

The concentrated aqueous greenhouse gas flow stream 111 may be coupled to a temporary storage container 118 that collects and stores the condensed or concentrated greenhouse gases from the first electrothermal swing adsorption apparatus 110, specifically the first chamber 112. As discussed above, the temporary storage container 118 may collect and store a specific greenhouse gas that was adsorbed by the carbon monoliths in the first electrothermal swing adsorption apparatus 110. In some embodiments, the temporary storage container 118 may include a flow path 119 that is in fluid communication with the wastewater feed flow path 115 via a first flow path 119A and is in fluid communication with the purge flow path 117 via a second flow path 119B.

The first electrothermal swing adsorption apparatus 110 operates in a continuous and cyclical manner. In other words, the wastewater feed 114 (e.g. wastewater input flow stream 102) is continuously introduced into the first chamber 112 to adsorb the aqueous greenhouse gases from the wastewater feed 114 and the purge 116 is continuously introduced into the second chamber 113 to desorb the greenhouse gases from the carbon monolith in the second chamber 113. When the active carbon monolith in the first chamber 112 begins to reach a predetermined adsorption capacity (e.g., in other words, the carbon monolith cannot adsorb much more greenhouse gases), the first electrothermal swing adsorption apparatus 110 can be reversed. In other words, the carbon monolith in the first chamber 112 can be regenerated by desorbing the greenhouse gases from the carbon monolith using the purge 116 and the carbon monolith in the second chamber 113 can be activated by adsorbing aqueous greenhouse gases from the wastewater feed 114. Accordingly, the first electrothermal swing adsorption apparatus 110 continuously adsorbs and desorbs greenhouse gases using the carbon monoliths in the first chamber 112 and the second chamber 113.

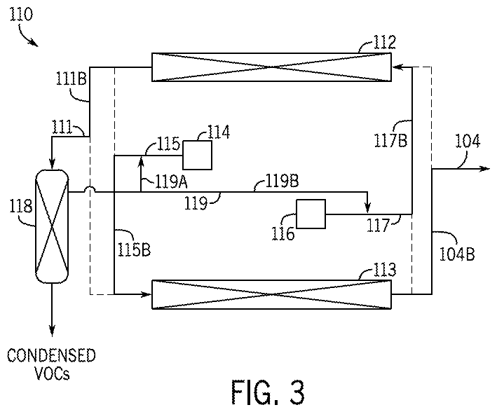

FIG. 3 illustrates a schematic of the first electrothermal swing adsorption apparatus 110 in a second configuration. The second configuration of the first electrothermal swing adsorption apparatus 110 is reversed from the first configuration of the first electrothermal swing adsorption apparatus 110. While FIG. 3 illustrates a schematic of the first electrothermal swing adsorption apparatus 110 in the second configuration, the electrothermal swing adsorption apparatuses 120, 130 in the second configuration are similar to the schematic of the first electrothermal swing adsorption apparatus 110 in the second configuration.

The first electrothermal swing adsorption apparatus 110 in the second configuration includes the first chamber 112 and the second chamber 113. In the illustrated embodiment of the second configuration of the first electrothermal swing adsorption apparatus 110, the first chamber 112 includes a regenerating carbon monolith for desorbing greenhouse gases and the second chamber 113 includes an active carbon monolith for adsorbing aqueous greenhouse gases. Previously, the regenerating carbon monolith of the first chamber 112 was the active carbon monolith of the first chamber 112 in the first configuration and the active carbon monolith of the second chamber 113 was the regenerating carbon monolith of the second chamber 113 in the first configuration. The first chamber 112 and the second chamber 113 operate in a cyclical fashion in this manner to perform continuous adsorption and desorption of greenhouse gases.

The first electrothermal swing adsorption apparatus 110 includes the wastewater feed 114. The wastewater feed 114 may be the same as the wastewater input flow stream 102. The wastewater feed 114 includes aqueous greenhouse gases dissolved in wastewater.

The wastewater feed 114 follows a wastewater feed flow path 115 that includes a second wastewater feed flow path 115B. The wastewater feed flow path 115 is introduced or received into the second chamber 113 via the second wastewater feed flow path 115B. The aqueous greenhouse gases are adsorbed by the active carbon monolith in the second chamber 113 thereby purifying the wastewater feed 114. The active carbon monolith in the second chamber 113 was the previous regenerating carbon monolith in the second chamber 113 in the first configuration. The second chamber 113 is coupled to the purified water output flow stream 104 so that the purified wastewater feed 114 to exit the second chamber 113. The purified water output flow stream 104 is free of greenhouse gases as they were desorbed by the active carbon monolith in the second chamber 113. In some embodiments, the purified water output flow stream 104, 104A is free of the specific greenhouse gas that the carbon monolith in the first chamber 112 was functionalized for and may include additional greenhouse gases that will be removed by subsequent electrothermal swing adsorption apparatuses (e.g., 120, 130) that are disposed later in series of the wastewater input flow stream 102 of the electrothermal swing adsorption system 100. As discussed above, the purified water output flow stream 104 may then be introduced or received into the second electrothermal swing adsorption apparatus 120 and then the third electrothermal swing adsorption apparatus 130. As discussed above, after the wastewater feed 114 can achieve significant reduction of aqueous greenhouse gases and nitrates.

The first electrothermal swing adsorption apparatus 110 further includes the purge 116. The purge 116 is a reservoir of purge water that is used in the desorption of the greenhouse gases from the carbon monolith in the first chamber 112 in the second configuration. In some embodiments, a purge gas is used in the desorption process. The purge 116 follows the purge flow path 117 that includes a second purge flow path 117B, which is different from the first purge flow path 117A. The purge 116 is introduced or received into the first chamber 112 via the second purge flow path 117B. The aqueous greenhouses gases are desorbed from the regenerating carbon monolith in the first chamber 112, which used to be the active carbon monolith in the first configuration. The regeneration of the regenerating carbon monolith in the first chamber 112 is performed by applying an electric current to the regenerating carbon monolith to induce heat by electrical resistance of the carbon monolith and increase the temperature of the carbon monolith to between 100° and 150° C. depending on the properties of the carbon monolith in the first chamber 112, the greenhouse gases being desorbed from the carbon monolith, and any chemical modifications of the carbon monolith. In some embodiments, the purge water is drained from the chamber before applying the electric current through the carbon monolith. The aqueous greenhouses gases are desorbed from the carbon monolith and into the purge 116. The condensed or concentrated greenhouse gases in the purge 116 may be transferred out of the first chamber 112 through the concentrated aqueous greenhouse gas flow stream 111 via a second concentrated aqueous greenhouse gas flow stream 111B.

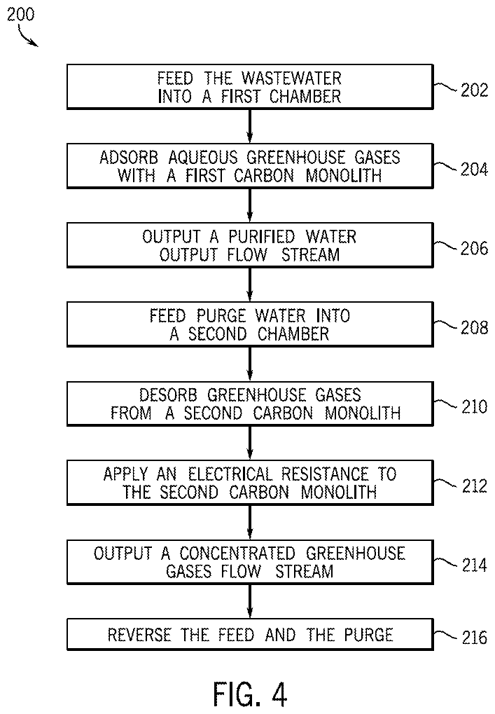

FIG. 4 illustrates a flowchart of a method 200 of capturing, concentrating, and sequestering aqueous greenhouse gases from wastewater in a wastewater treatment facility using the first electrothermal swing adsorption apparatus 110. However, this method is also applicable to the second electrothermal swing adsorption apparatus 120 and the third electrothermal swing adsorption apparatus 130.

Step 202 is directed to feeding the wastewater feed 114 with aqueous greenhouse gases into the first chamber 112 of the first electrothermal swing adsorption apparatus 110. The wastewater feed 114 may contain more than one type of aqueous greenhouse gases, such as methane, nitrous oxide, carbon monoxide, and carbon dioxide. Step 204 is directed to adsorbing the aqueous greenhouse gases with a first carbon monolith in the first chamber 112. In some embodiments, the first carbon monolith is functionalized to adsorb a specific aqueous greenhouse gas. In some embodiments, the carbon monolith may be functionalized to adsorb more than one type of aqueous greenhouse gas.

In some examples, step 204 of adsorbing the aqueous greenhouse gases with a first carbon monolith in the first chamber can include moving the first carbon monolith through the wastewater. In other words, step 204 can include establishing a moving bed that includes moving the carbon monolith through the wastewater and then moving the carbon monolith to a separate location for release of the captured aqueous greenhouse gas components.

Step 206 is directed to outputting a purified water output flow stream 104 from the first chamber 112 of the first electrothermal swing adsorption apparatus 110. In some embodiments, the purified water output flow stream 104 is free of the specific aqueous greenhouse gas that was adsorbed by the first carbon monolith in the first chamber 112 but might contain additional aqueous greenhouse gases that will be removed by the electrothermal swing adsorption apparatuses 120, 130.

Step 208 is directed to feeding purge water into the second chamber 113 of the first electrothermal swing adsorption apparatus 110 that is separate from the first chamber 112. Step 210 is directed to desorbing greenhouse gases from a second carbon monolith with the purge water in the second chamber 113. The adsorption of the aqueous greenhouse gasses in the first chamber 112 occurs simultaneously as the desorption of the greenhouse gases in the second chamber 113. In some embodiments, the second carbon monolith had previously adsorbed aqueous greenhouse gases. In some situations, the second carbon monolith may not have adsorbed any aqueous greenhouse gases, such as when the carbon monolith is first added to the second chamber 113 and is being used for the first time. Step 212 is directed to applying an electrical current to the second carbon monolith in the second chamber 113 to raise the temperature of the regenerating carbon monolith to desorb the captured greenhouse gases from the regenerating carbon monolith. The temperature can be raise to between 100° and 150° C. The temperature is raised to aid in the desorption process. Accordingly, raising the temperature occurs at the same time as the desorption step 210. Step 214 is directed to outputting a concentrated aqueous greenhouse gas flow stream 111 from the second chamber 113 of the first electrothermal swing adsorption apparatus 110.

Step 216 is directed to reversing the feed of the wastewater with aqueous greenhouse gases from the first chamber 112 to the second chamber 113 and reversing the feed of the purge water from the second chamber 113 to the first chamber 112 when the first carbon monolith has adsorbed a predetermined amount of aqueous greenhouse gases. In other words, the carbon monolith has reach a predetermined adsorption capacity. In some embodiments, the first chamber 112 and the second chamber 113 may each comprise a sensor to monitor the amount of aqueous greenhouses gases the carbon monolith has adsorbed so that the first electrothermal swing adsorption apparatus 110 may be reversed so that the aqueous greenhouses gases are be removed from the carbon monolith for repurposing. In some embodiments, a carbon monolith adsorbs aqueous greenhouse gases for a predetermined amount of time based on the concentration of the aqueous greenhouse gases in the wastewater. The predetermined amount of time can be determined by adsorption calculation of the carbon monolith. Accordingly, the second carbon monolith in the second chamber 113 can adsorb the aqueous greenhouse gases and the carbon monolith in the first chamber 112 can be desorbed of the greenhouse gases captured in the carbon monolith.

Carbon fibers are good conductors of electricity and heat, the amount of energy needed through the electrothermal process to raise their temperature is relatively low. The lower cost of coal-based active carbon fibers and the lower operating cost of electrothermal swing adsorption/desorption enables coal-based electrothermal swing adsorption to be cost competitive with existing legacy municipal water treatment systems, especially usage of granular activated carbon. When compared to the incumbent legacy system—granulated activated carbon—the electrothermal swing adsorption will have, at least, 60% lower carbon intensity due to lower energy consumption, and an increased cycle life compared to granulated activated carbon.

Implementation of electrothermal swing adsorption of aqueous greenhouse gases has at least three benefits. First, reduced consumption of energy directly and indirectly. Second, significant reduction of methane, nitrous oxide, and carbon monoxide from wastewater treatment. Third, decreased usage and dependence on granulated activated carbon in wastewater treatment.

As used herein, the term “about” or “substantially” refers to an allowable variance of the term modified by “about” or “substantially” by ±10% or ±5%. Further, the terms “less than,” “or less,” “greater than,” “more than,” or “or more” include, as an endpoint, the value that is modified by the terms “less than,” “or less,” “greater than,” “more than,” or “or more.”

While various aspects and embodiments have been disclosed herein, other aspects and embodiments are contemplated. The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

Various inventions have been described herein with reference to certain specific embodiments and examples. However, they will be recognized by those skilled in the art that many variations are possible without departing from the scope and spirit of the inventions disclosed herein, in that those inventions set forth in the claims below are intended to cover all variations and modifications of the inventions disclosed without departing from the spirit of the inventions. The terms “including” and “having” come as used in the specification and claims shall have the same meaning as the term “comprising.”

What is claimed is:

1. An electrothermal swing adsorption system comprising:
an electrothermal swing adsorption apparatus comprising:
a first chamber comprising at least one carbon monolith; and
a second chamber comprising at least one carbon monolith;
wherein the electrothermal swing adsorption apparatus is configured to receive a feed of a wastewater with at least one greenhouse gas dissolved therein;
wherein the electrothermal swing adsorption apparatus outputs a purified water flow stream; and
wherein the electrothermal swing adsorption apparatus outputs a concentrated aqueous greenhouse gas flow stream.

2. The electrothermal swing adsorption system of claim 1, wherein the at least one carbon monolith of the first chamber adsorbs aqueous greenhouse gases and the at least one carbon monolith of the second chamber desorbs greenhouse gases simultaneously as the at least one carbon monolith of the first chamber adsorbs aqueous greenhouse gases.

3. The electrothermal swing adsorption system of claim 1, wherein the at least one carbon monolith of the second chamber adsorbs aqueous greenhouse gases and the least one carbon monolith of the first chamber desorbs greenhouse gases simultaneously as the at least one carbon monolith of the first chamber adsorbs aqueous greenhouse gases.

4. The electrothermal swing adsorption system of claim 1, wherein the first chamber and the second chamber operate in a cyclical fashion to perform continuous adsorption and desorption of greenhouse gases such that adsorption occurs in one of the first chamber and the second chamber while desorption occurs in the other of the first chamber and the second chamber.

5. The electrothermal swing adsorption system of claim 1, wherein each carbon monolith comprises coal-based activated carbon fibers.

6. The electrothermal swing adsorption system of claim 1, wherein each carbon monolith is functionalized to adsorb a specific aqueous greenhouse gas.

7. The electrothermal swing adsorption system of claim 2, wherein the electrothermal swing adsorption apparatus comprises a container to store aqueous greenhouse gases desorbed from the at least one carbon monolith of the second chamber.

8. The electrothermal swing adsorption system of claim 1, further comprising a plurality of electrothermal swing adsorption apparatuses that are arranged in series such that each electrothermal swing adsorption apparatus adsorbs aqueous greenhouse gases from the feed of the wastewater.

9. The electrothermal swing adsorption system of claim 8, wherein each electrothermal swing adsorption apparatus outputs the concentrated aqueous greenhouse gas flow stream for a specific aqueous greenhouse gas.

10. The electrothermal swing adsorption system of claim 9, wherein each electrothermal swing adsorption apparatus comprises a container to store the outputted specific aqueous greenhouse gas.

11. The electrothermal swing adsorption system of claim 1, wherein the electrothermal swing adsorption apparatus further comprises at least one chromatography column configured to adsorb the at least one greenhouse gas dissolved in the wastewater.

12. A method of removing greenhouse gases from wastewater utilizing a electrothermal swing adsorption system comprising:
feeding wastewater with aqueous greenhouse gases into a first chamber of an electrothermal swing adsorption apparatus;
adsorbing the aqueous greenhouse gases with a first carbon monolith in the first chamber; and
outputting a purified water flow stream from the first chamber of the electrothermal swing adsorption apparatus.

13. The method of claim 12, further comprising:
feeding purge water into a second chamber of the electrothermal swing adsorption apparatus that is separate from the first chamber; and
desorbing greenhouse gases from a second carbon monolith with the purge water in the second chamber, wherein the second carbon monolith previously adsorbed aqueous greenhouse gases.

14. The method of claim 13, further comprising outputting a concentrated aqueous greenhouse gas flow stream from the second chamber of the electrothermal swing adsorption apparatus.

15. The method of claim 13, further comprising applying an electrical current to the second carbon monolith in the second chamber to raise a temperature of the second carbon monolith to desorb the greenhouse gases from the second carbon monolith.

16. The method of claim 13, further comprising reversing the feed of the wastewater with aqueous greenhouse gases from the first chamber to the second chamber and reversing the feed of the purge water from the second chamber to the first chamber when the first carbon monolith has adsorbed a predetermined amount of aqueous greenhouse gases.

17. The method of claim 12, wherein adsorbing the aqueous greenhouse gases with a first carbon monolith in the first chamber comprises moving the first carbon monolith through the wastewater, purge water, or a gas.

18. The method of claim 13, wherein the first carbon monolith and the second carbon monolith comprise coal-based activated carbon fibers.

19. The method of claim 18, wherein the coal-based activated carbon fibers are functionalized to adsorb a specific aqueous greenhouse gas.

20. The method of claim 13, wherein the electrothermal swing adsorption system comprises a plurality of electrothermal swing adsorption apparatuses that are arranged in series, wherein the wastewater with aqueous greenhouse gases is feed into each electrothermal swing adsorption apparatus in series and each electrothermal swing adsorption apparatus adsorbs a specific aqueous greenhouse gas.
